(19) United States
(12) Patent Application Publication
(10) Pub. No.: US 2007/0013719 A1
(43) Pub. Date: Jan. 18, 2007

(54) Image processing apparatus, image processing method, storage medium, and program

(75) Inventor: Kunihiro Yamamoto, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/523,864

(22) Filed: Sep. 19, 2006

Related U.S. Application Data
(62) Division of application No. 10/885,804, filed on Jul. 8, 2004.

(30) Foreign Application Priority Data
Jul. 16, 2003 (JP) 2003-275710

(51) Int. Cl. G09G 5/00

(52) U.S. Cl. 345/629

(57) ABSTRACT

An image processing apparatus includes a storing unit for storing, in a storage medium, image data of an image to be displayed on a display unit; a rendering unit for rendering characters in a character rendering region specified on the image; and a controlling unit for performing display control processing. When characters are superimposed on an image and the resulting image is displayed, image data of a region of the image, the region being corresponding to the character rendering region, is stored in the storage medium, the characters are rendered to the image data of the image, the resulting image is displayed on the display unit, and then the image data saved in the storage medium is rendered back to the image data of the displayed image. This arrangement can restrain increases in the amount of memory used and processing load and can prevent the flickering of displayed characters.

### BACKGROUND OF THE INVENTION

1. Field of the Invention

The present invention relates to an image processing apparatus, an image processing method, a storage medium, and a program.

2. Description of the Related Art

Conventionally, characters are displayed superimposed on images, i.e., are rendered superimposed with their background being transparent, to print the characters on circular printing media, such as printable CD-Rewritable discs.

For example, for creation of pamphlets and so on, a technology has been available in which a virtual layout rectangle for arrangement of a character group is specified and the character size is automatically determined in accordance with the layout rectangle.

However, such a technology has a problem in cases in which characters are sequentially displayed superimposed on an image, such as case in which characters are displayed in conjunction with interactive character input. Specifically, when characters are superimposed on a rendered image in a simple manner, the displayed characters flicker, thereby giving an unpleasant feeling to the operator. The flickering of the displayed characters occurs due to the following processing. That is, an image is re-rendered every time a single character is input, the characters are sequentially superimposed to cause portions of the image which are supposed to be hidden by the characters to be instantaneously displayed, and the characters are then displayed. Accordingly, a so-called “double buffering technique” has conventionally been employed to restrain the flickering of displayed characters, but has problems in that the amount of memory used and the processing load increase.

Printable CD-Writable discs, which are one type of circular printing media, have printable regions that differ for each medium. Thus, there is a problem in that, for example, when an attempt is made to print characters, arranged to fit into a small medium having a small-inner diameter printable region, onto a medium having a larger diameter, character loss can happen. While an approach in which a layout rectangle for arrangement of characters is specified as in Japanese Patent Laid-Open No. 5-307255 and the character size is determined based on the layout rectangle is also possible, such an approach leads to an increase in workload since the operator needs to set the layout rectangle.

### SUMMARY OF THE INVENTION

It is an object of the present invention to overcome at least one of the problems described above.

A feature of the present invention is to allow characters to be superimposed on an image and be displayed while restraining increases in the amount of memory used and the processing load and preventing flickering of characters displayed.

Another feature of the present invention is to prevent the occurrence of character loss when characters are printed on a circular recording medium.

To achieve the foregoing object and features, the present invention provides an image processing apparatus. The image processing apparatus includes storing means, rendering means, and controlling means. The storing means stores, in a storage medium, image data of an image to be displayed on displaying means. The rendering means renders characters in a character rendering region specified on the image. The controlling means performs display control processing. In the display control processing, image data of a region of the image, the region being corresponding to the character rendering region, is saved in the storage medium when the image is displayed; the characters are rendered to the image data of the image; the resulting image is displayed on the displaying means; and then the saved image data is rendered back to the image data of the displayed image.

Further objects, features and advantages of the present invention will become apparent from the following description of the preferred embodiments with reference to the attached drawings.

### BRIEF DESCRIPTION OF THE DRAWINGS

FIG. 1 is a block diagram of an exemplary configuration of a computer system capable of achieving features of an image processing apparatus according to embodiments of the present invention.

FIG. 2 is a diagram illustrating the relationship between an image and text which are displayed.

FIG. 3 is a flow chart of a processing operation of a known image processing apparatus when characters are input.

FIG. 4 is a flow chart of a processing operation of the image processing apparatus of the first embodiment when characters are input.

FIGS. 5A to 5D illustrate examples in which the font size and the rendering position are changed depending on the length of a character string.

FIG. 6 is a flow chart of a processing operation of an image processing apparatus of a second embodiment.

FIG. 7 is a view illustrating a printable region on a circular printable medium.

FIGS. 8A to 8C illustrate examples of an automatic adjusting method for a text rendering region in a third embodiment.

FIGS. 9A and 9B illustrate other examples of the automatic adjusting method for the text rendering region in the third embodiment.

FIG. 10 is a view illustrating the relationship between a text rendering region and a printable region.

FIG. 11 is a view showing another example of the automatic adjusting method for the text rendering region in the third embodiment.

### DESCRIPTION OF THE PREFERRED EMBODIMENTS

Embodiments of the present invention will be described below with reference to the attached drawings.

### First Embodiment

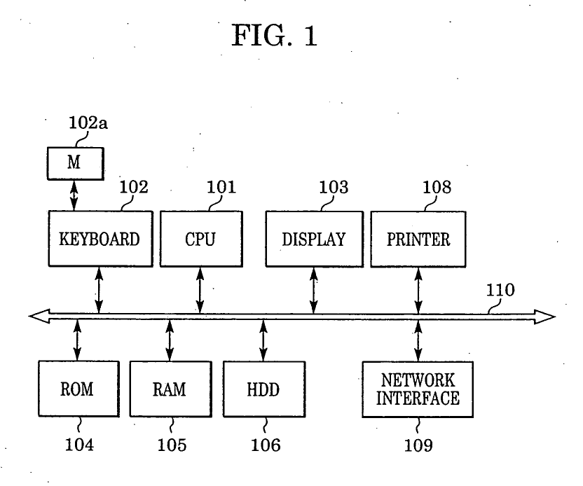

FIG. 1 is a block diagram showing an exemplary configuration of a computer system (hereinafter simply referred to as a “system”) for achieving features of an image processing apparatus according to a first embodiment of the present invention.

FIG. 1, a CPU (central processing unit) 101 controls the entire system. A keyboard 102 and a mouse 102a are used to enter instructions, characters, and so on. A display 103 is implemented by, for example, a CRT (cathode ray tube) display or a liquid crystal display. A ROM (read only memory) 104 and a RAM (random access memory) 105 constitute a storage device of the system to store programs executed by the system and data used by the system.

A hard disk drive (HDD) 106 is included in an external storage device used for a file system of the system. A printer 108 is also provided in the system. A network interface 109 transmits and receives data to and from another apparatus (not shown) and so on through a network. The elements 101 to 109 are interconnected via a bus 110 so as to allow communication with each other.

In the system shown in FIG. 1, the CPU 101 performs control for achieving operations in the present embodiment. Specifically, the CPU 101 reads a program for achieving operations as described below from the ROM 104 (or the HDD 106) and executes the program to control the individual elements connected to the bus 110. In this case, the RAM 105 serves as, for example, a main memory or a work memory for the CPU 101. The CPU 101, the ROM 104, the RAM 105, and so on realize the features of storing means, rendering means, controlling means, saving means, restoring means, region determining means, and so on of the present invention.

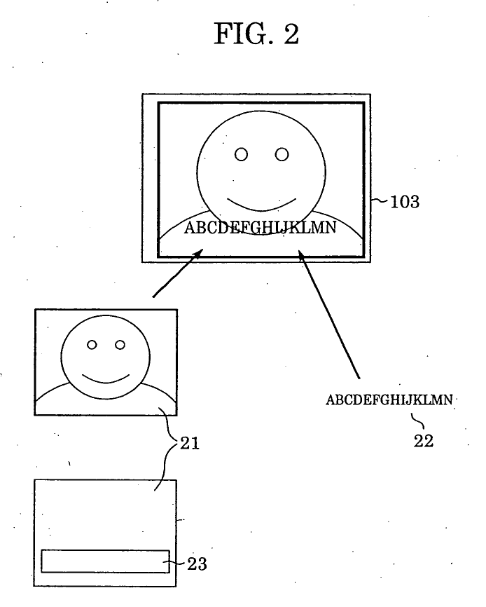

FIG. 2 is a diagram illustrating the relationship between an image and text which are displayed on the screen of the display 103. In FIG. 2, an image 21 is a bitmap image and the image data thereof is stored in the RAM 105 separately from character data. Text 22 consists of characters (i.e., a character group) that are displayed superimposed on the image 21. A text display region (a text rendering region) 23 is a coordinate rectangle that specifies a region where the characters are superimposed. The text 22 is rendered in the center of the text display region 23 with a transparent background.

As shown in FIG. 2, the text 22 is displayed at coordinates according to the text display region 23, so that the image 21 and the text 22 are displayed on the display 103. In this case, the image 21 is enlarged or reduced so as to fit into a desired display region. In accordance with character-string information (text data) stored in the RAM 105, the text 22 is converted by the system into a character-representing bitmap image and is then rendered directly on the screen or on the image 21.

Character-string information for the text 22 may be static information pre-stored in the RAM 105. With this approach, however, when a character string that is sequentially input by a user through the keyboard 102 and so on is displayed, flicker occurs as in the conventional method described above.

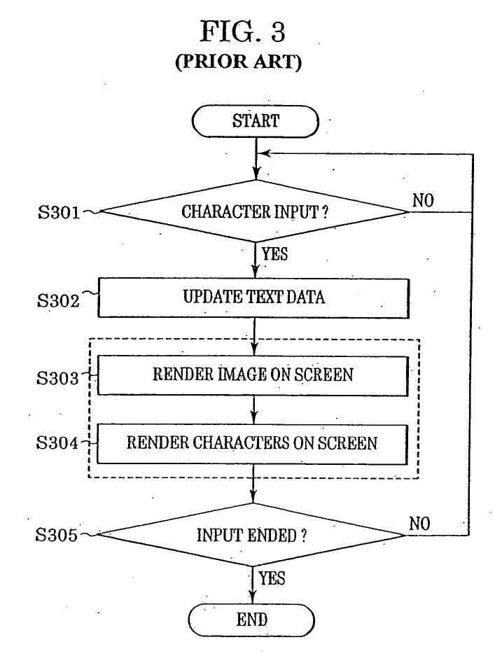

Now, a known processing operation during input of a character string will be described with reference to FIG. 3.

First, in step S301, a determination is made as to whether or not there is character input (key entry) through the keyboard 102 or the like. When there is no character input, the process in step S301 is repeated. Thus, the process in step S301 forms a processing loop for monitoring the keyboard 102 and so on (i.e., a processing loop for waiting for key entry or the like through the keyboard 102). When there is character entry, the process proceeds to S302.

In step S302, the text 22 (i.e., the character-string information of the text 22) is updated in accordance with the character input. The text 22, which is controlled separately from the data of the image 21, is updated for each character input in the order of, for example, “”, “A”, “AB”, “ABC”, . . . and so on starting from the state of a blank character string.

In step S303, the image 21 is rendered on the screen of the display 103. More specifically, the content (i.e., the image data) of the image 21 is copied into a predetermined region (e.g., a VRAM: video random access memory) in the RAM 105 in which content to be displayed on the screen of the display 103 is stored. Since the number of pixels on the screen and number of pixels of the image 21 may be the same but are typically different from each other, the content of the image 21 is copied into the RAM 105 while being subjected a known enlarging or reducing processing.

In step S304, every time a character is input, character-string information (i.e., text data) is converted into a bitmap image and then the text 22 is rendered on the image 21 in the predetermined region (the VRAM) of the RAM 105. It is illustrated in the example of FIG. 2 that the text 22 is displayed with a magnification of about 1.5. In practice, however, when the size of the image 21 is larger than the size of a display region on the screen, the size of the text 22 may be reduced for display.

In step S305, a determination is made as to whether or not the character input processing has completed. When the result of the determination indicates that the character input processing continues, the process returns to step S301.

In the known processing operation shown in FIG. 3, every time a character is input, portions of the image 21 which are supposed to be hidden by the text 22 are temporarily (instantaneously) displayed (in step S303) on the screen and then the text 22 is displayed (in step S304). As a result, there is a problem in that that the rendered characters look like flickering, thus giving an unpleasant feeling to the operator.

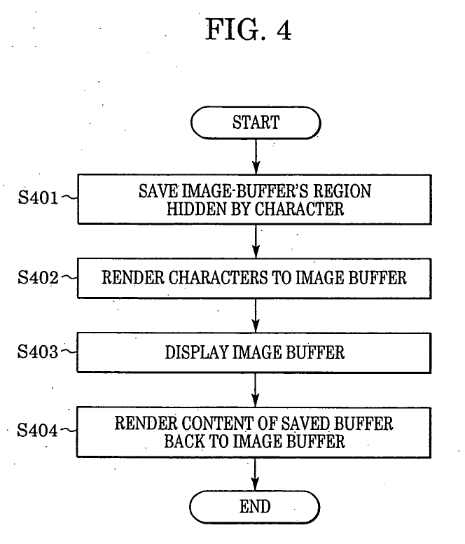

Accordingly, in the present embodiment, the above-described known problem is overcome by replacing the processing in steps S303 and S304, surrounded by the dotted line in FIG. 3, with processing described below and shown in FIG. 4.

FIG. 4 is a flow chart of a processing operation during input of a character string in the present embodiment. FIG. 4 shows a part of the processing operation. That is, after the processing in steps S301 and S302 shown in FIG. 3 is executed, processing shown in FIG. 4 is executed and then the processing in step S305 show in FIG. 3 is executed. The CPU 101 achieves the series of processing, as described above, by reading a program from the ROM 104 or the like and executing the program to thereby control the individual elements.

In step S401, the image data of a portion of the image 21, the portion being corresponding to the rectangular text-display region 23, is saved (copied) in the RAM 105 (specifically, a save area in the RAM 105).

In step S402, the text 22 is directly rendered to the image 21 stored in a predetermined area (e.g., the VRAM) in the RAM 105.

In step S403, the image 21 is displayed on the screen of the display 103. At this point, since the image data of the image 21 is in a state in which the text 22 is already superimposed by the processing in step S402, the image 21 and the text 22 are displayed on the screen of the display 103 at the same time. Thus, the text 22 can be displayed superimposed on the image 21 without the occurrence of flicker in the text 22.

In step S404, the image data that has been saved in the RAM 105 (i.e., the image data of a portion corresponding to the text display region 23) is rendered back to the image 21. Consequently, the image data of the image 21 is restored to its initial state in which the text 22 is not superimposed. Thus, this subroutine can be repeatedly executed. That is, even when a change is made to the text 22 in step S302 shown in FIG. 3, the processing operation shown in FIG. 4 can be performed again.

Repeatedly executing the above-described processing operation allows an image displayed on the screen of the display 103 to be continuously updated, without flicker, in response to the operator's character input. Holding a pre-input state also allows for modification of input characters.

While the image data of a portion of the image 21, the portion being corresponding to the text display region 23, is saved in the RAM 105 in step S401 in the first embodiment described above, the present invention is not limited thereto.

For example, when the text 22 that is rendered superimposed on the image 21 is short (e.g., a single character, such as “A”), saving the image data of an entire portion corresponding to the text display region 23 shown in FIG. 2, i.e., the image data of a portion corresponding to the entire text display region 23, in the RAM 105 results in a large amount of memory waste. Thus, in such a case, the arrangement may be such that a region on which each character is to be superimposed is calculated and only the image data of a portion based on the calculation result may be saved in the RAM 105. This allows a reduction in the amount of memory used and also allows a reduction in processing load.

In some cases, however, it is not necessarily easy to determine, of the image 21, a region on which the text 22 is superimposed, for example, in a case in which a proportional font pitch is used to render the text 22. In such a case, the image data of an entire portion corresponding to the text display region 23 may be saved. Also, two method described above may be selectively used depending on the text 22 to be superimposed.

While the image data of an image to be displayed and the image data of a portion corresponding to the text display region 23 are stored in the RAM 105 in the first embodiment, the respective image data may be stored in different storage areas in the same memory or may be stored in different memories.

While the simplest case, i.e., the case in which only one image and one text are displayed, has been described in the first embodiment by way of example, the present invention is not limited thereto. For example, the present invention is also applicable to more complicated cases, such as a case in which a plurality of images are displayed on the display 103 and a plurality of texts are further superimposed on each image.

### Second Embodiment

A second embodiment of the present invention will now be described.

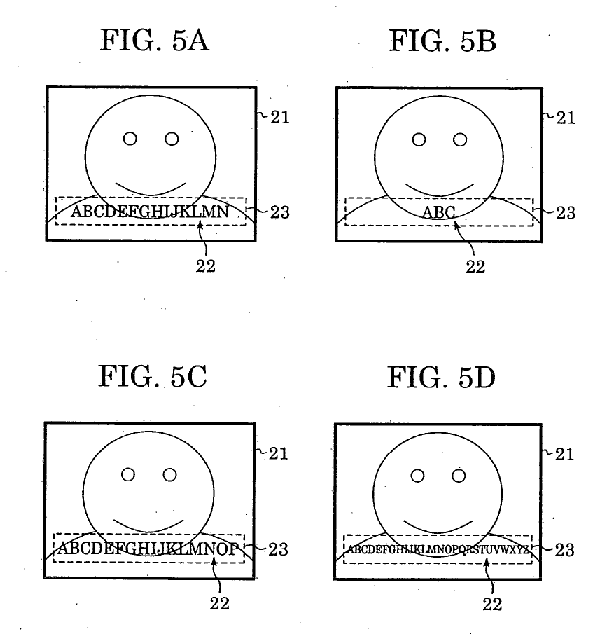

The description in the first embodiment above has been given assuming that the text 22 fits into the text display region 23. However, when the operator enters a relatively long character string, the characters may not fit into the text display region 23. In such a case, in general, some characters of the text 22 which do not fit into the text display region 23 are truncated (an example of such a case will be described below and shown in FIG. 5C) or the input of text with a certain length or longer is prohibited.

In contrast, in a second embodiment described below, based on the text display region 23 and the text 22, the character font size is automatically changed so that the entire text 22 fits into the text display region 23. The hardware configuration and so on of an image processing apparatus in the second embodiment is analogous to that in the first embodiment, and thus the description thereof is omitted.

FIGS. 5A to 5D are views illustrating examples in which the font size and the rendering position are changed in accordance with the length of a character string. For convenience of illustration in FIGS. 5A to 5D, the text display region 23 is indicated by a dotted line, which is not rendered in practice.

FIG. 5A shows an example in which the text 22 just fits into the text display region 23 specified on the image 21.

FIG. 5B shows a case in which the text 22 is short relative to the text display region 23 specified on the image 21. As shown, since the text 22 is rendered by commonly known processing, such as centering and left or right justification, the description of the processing is omitted.

FIG. 5C shows a conventional example of a case in which the text 22 is too long to fit into the text display region 23 specified on the image 21. Specifically, FIG. 5C illustrates a case in which the text 22 to be displayed in the text display region 23 is “ABCDEFGHIJKLMNOPQRSTUVWXYZ”. However, with the same font size as that shown in FIG. 5C, the text 22 does not fit into the text display region 23, and thus as many characters as possible from the left end of the text 22 are displayed.

FIG. 5D also shows a case in which the text 22 to be displayed is longer than the text display region 23 specified on the image 21. Unlike the example shown in FIG. 5C, with a reduced font size, the entire text 22 is displayed in the text display region 23.

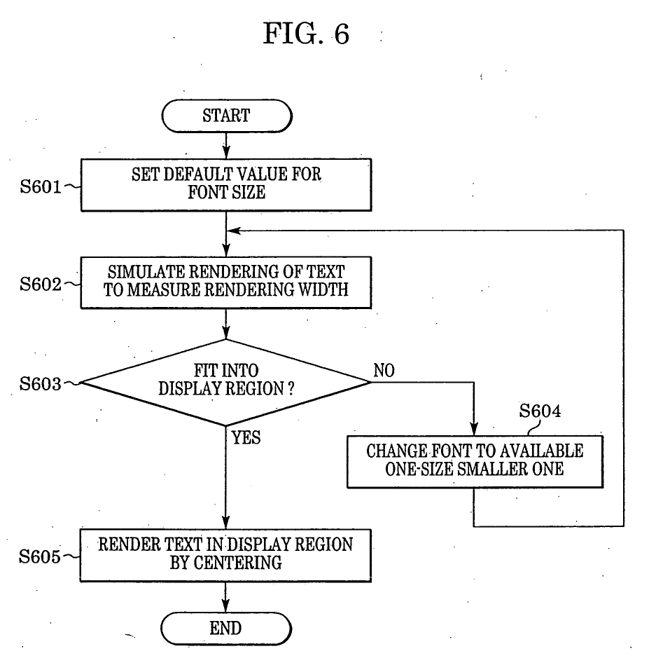

A description will now be given of a method for calculating a font size for rendering a long text 22 as shown in FIG. 5D in the text display region 23. For a case in which the text 22 is rendered with a fixed pitch font, a method for calculating a font size therefor is obvious since the character width and the character pitch are constant regardless of the content of the text 22. In the present embodiment, a font-size determination method that is also applicable to a case in which the text 22 is rendered with a proportional pitch font will be described with reference to FIG. 6.

FIG. 6 is a flow chart of a processing operation in which a font size for the text 22 is automatically determined in accordance with the text display region 23 to render characters.

In step S601, a default value for the font size is set. The default size is determined with reference to, for example, the height of the text display region 23. Since the font size is typically specified by a font height, a font size with which the height of the text display region 23 and the font height match each other is used for the default value. A font size with which a height, obtained by multiplying a predetermined appropriate magnification constant (e.g., 0.95) by the height of the text display region 23, and the font height match each other may be used for that default value.

In step S602, the rendering of the text 22 is simulated with a specified font size to determine the rendering width. For example, many recent operating systems (OSs), such as Microsoft Windows, are provided with functions for determining a width required for rendering without actually rendering text. Without the use of such a simple function, the text 22 may actually be rendered in a memory area (e.g., the save area in the RAM 105 in the first embodiment) that is not used for screen display to measure a width required for the rendering.

In step S603, the width of the text display region 23 and the rendering width determined in step S602 are compared. When the comparison result indicates that the rendering width is smaller than-the width of the text display region 23, i.e., the text 22 fits into the text display region 23, the process proceeds to step S605. In step S605, the text 22 is rendered in the text display region 23 by centering, and the process ends.

On the other hand, when the comparison result in step S603 indicates that the rendering width is greater than the width of the text display region 23, i.e., the text 22 does not fit into the text display region 23, the process proceeds to step S604. In step S604, the font size is changed to an available one-size smaller font size. After the change of the font size, the process returns to step S602, in which the above-described processing is performed. Although there are some exceptions, the font size is specified by an integer point value in many cases and thus is not typically a continuous quantity (for example, a smaller size next to a 16-point font size is typically 15 points and thus 15.9 points cannot be specified). Thus, the font size in this case can be specified with a “next smaller (one-size smaller) font size”. On the other hand, for a system in which the font size can be specified with a continuous value, the current font size may be replaced with, for example, a 1% smaller font size.

Performing the processing described above allows the font size to be automatically adjusted such that the text 22 is rendered so as to fit into the specified text display region 23.

While the most basic method for searching for a font size has been described in the second embodiment by way of example, the method is not necessary the most efficient method for searching for an appropriate font size. Thus, for example, in step S603 described above, about what percentage of the text 22 does not fit into the width of the text display region 23 may be determined so that, based on the determination result, a font size to be tried next can be determined in step S604. Known binary search or the like may also be used to achieve more efficient searching for an appropriate font size.

### Third Embodiment

A third embodiment of the present invention will now be described.

In the third embodiment described below, when characters are printed on a printing medium such as a circular printable medium, the position and the size of the character rendering region are automatically adjusted in accordance with a printable region on the recording medium. Since the hardware configuration and so on of an image processing apparatus according to the third embodiment is analogous to that shown in the first embodiment, the description thereof is omitted. In the present embodiment, the CPU 101, the ROM 104, the RAM 105, and so on achieves the features of character specifying means, adjusting means, print controlling means, and so on of the present invention.

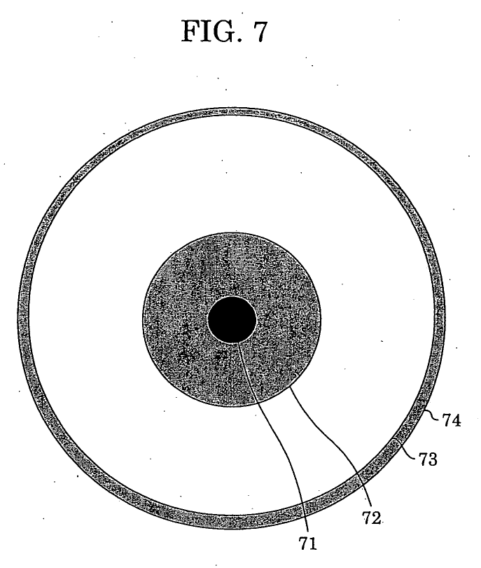

First, an overview of a printable surface of a printable medium typified by a Printable CD-Rewritable disc will be described with reference to FIG. 7. In FIG. 7, reference numeral 71 indicates a center hole provided in the printable medium, 72 is the inner diameter of a printable region, 73 is the outer diameter of the printable region, and the 74 is the outer circumference of the printable medium. That is, the region between the inner diameter 72 and the outer diameter 73 serves as the printable region (printable area), in which an image and so on can be printed using the printer 108. The printable region differs depending on printable media, which are available on the market in various types, or circular labels for the printable media. In the present embodiment, therefore, the position and the size of a text rendering region are automatically adjusted in accordance with the printable region of each printable medium, so that text and so on can be appropriately printed without manual adjustment of the text and so on.

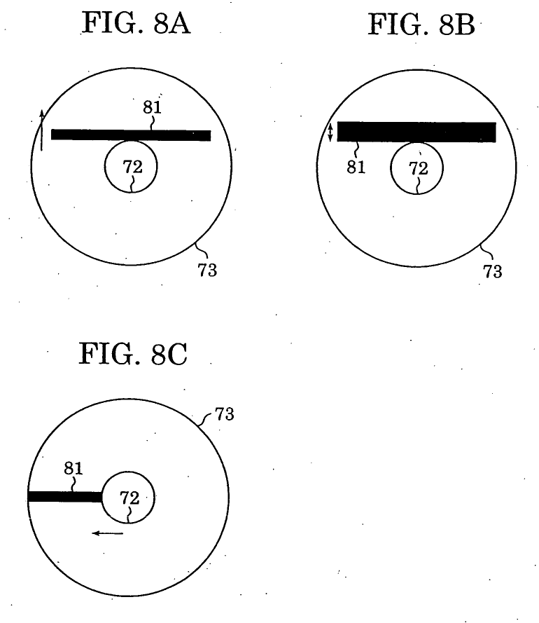

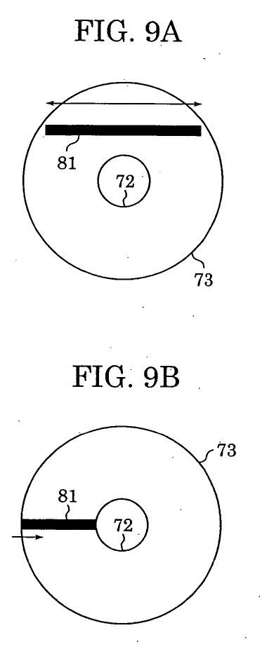

FIGS. 8A to 8C and 9A and 9B show an overview of automatic adjustment in a text rendering region in the third embodiment. In each of FIGS. 8A to 8C and 9A and 9B, two concentric circles 72 and 73 indicate the inner diameter and the outer diameter of a printable region, respectively, and are pre-defined. A rectangle region 81 (shown in black in FIGS. 8A to 8C and 9A and 9B) is specified such that characters, i.e., text, are rendered therein. For ease of illustration in FIGS. 8A to 8C and 9A and 9B, the longitudinal side of the rectangle region 81 is referred to as the “width” of the text rendering region and the short side of the rectangle region 81 is referred to the “height”.

FIG. 8A shows a state in which text is arranged adjacent to the inner diameter 72 (i.e., one longitudinal side of a text rendering region 81 is in contact with the inner diameter 72). When the inner diameter 72 is larger than that shown in FIG. 8A, text loss can be prevented by moving the text rendering region 81 in the radial direction, which is perpendicular to the longitudinal sides of the text rendering region 81, (i.e., in the upward direction in FIG. 8A) from the inner diameter 72 toward the outer diameter 73.

FIG. 8B also shows a state in which text is arranged adjacent to the inner diameter 72, similarly to that shown in FIG. 8a. In this case, in order to deal with an increase in the inner diameter 72, the height of the text rendering region 81 (or the character height) is reduced. Thus, text loss can also be prevented by reducing the height of the text rendering region 81.

As shown in FIGS. 8A and 8B, when the text is arranged adjacent to the inner diameter 72, two approaches, that is, moving the text position (i.e., the position of the text rendering region 81) and adjusting the text height (the height of the text rendering region 81), are available. Either of the approaches can selectively be used or both methods can be used in combination to prevent text loss.

FIG. 8C shows a case in which one short side of the text rendering region 81 is arranged in contact with the inner diameter 72 (i.e., a state in which one short side of the text rendering region 81 is adjacent to the left side of the inner diameter 72 shown in FIG. 8C). When the inner diameter 72 is greater than that shown in FIG. 8C, text loss can be prevented by reducing the width of the text rendering region 81.

FIG. 9A shows a state in which text is arranged adjacent to the outer diameter 73 (i.e., the text rendering region 81 is in contact with the outer diameter 73). When the outer diameter 73 is smaller than that shown in FIG. 9A, text loss can be prevented by reducing the width of the text rendering region 81 (e.g., by reducing the width of the text rendering region 81 shown in FIG. 9A by the same amount for the two opposite ends).

FIG. 9B shows a sate in which text is arranged in contact with both of the outer diameter 73 and the outer diameter 72 (i.e., a state in which one short side of the text rendering region 81 is in contact with the outer diameter 73 and the other short side is in contact with the inner diameter 72). In this case as well, when the outer diameter 73 is smaller than that shown in FIG. 9B, text loss can be prevented by reducing the width of the text rendering region 81. However, as can be understood from the arrows shown in the figures, the approach for reducing the width of the text rendering region 81 is different from that shown in FIG. 9A. That is, in FIG. 9B, for example, only the left side of the text rendering region 81 is reduced.

As described above, in response to an increase in the inner diameter 72 and/or a decrease in the outer diameter 73, the position, width, and height of the text rendering region 81 are adjusted, using the method considering the text position (the position of the text rendering region 81), based the pre-defined inner diameter and outer diameter. This can prevent text to be rendered in the text rendering region 81 from protruding from a printable region on a printable medium and thus can prevent text loss (i.e., text truncation). While a description is not given, the present embodiment can similarly be applied to a case in which the text rendering region 81 is located below or at the right side of the inner diameter 72.

Thus, in the present invention, the font size is automatically adjusted in the same manner as in the second embodiment and text is rendered on the text rendering region 81 that are automatically adjusted as described above. As a result, any text can be automatically and optimally rendered in a specified printable region.

With respect to the automatic adjustment of the text rendering region 81 illustrated in FIGS. 8A to 8C and 9A and 9B by way of example, since an algorithm for adjusting the text rendering region 81 other than the pattern shown in FIG. 9A is obvious from the figures, the description thereof is omitted. A method for adjusting the text rendering region 81 for the pattern shown in FIG. 9A will be described below. In some cases, as a result of the adjustment for the state in FIG. 8A, the text rendering region 81 moves in the upward direction and may come into contact with the outer diameter 73, but the reverse cannot happen. That is, these two adjustments have an order. Adjustment for the state shown in FIG. 8A is first performed and then adjustment for the state shown in FIG. 9A is performed.

A method for adjusting the text rendering region 81 for the pattern shown in FIG. 9A will now be described.

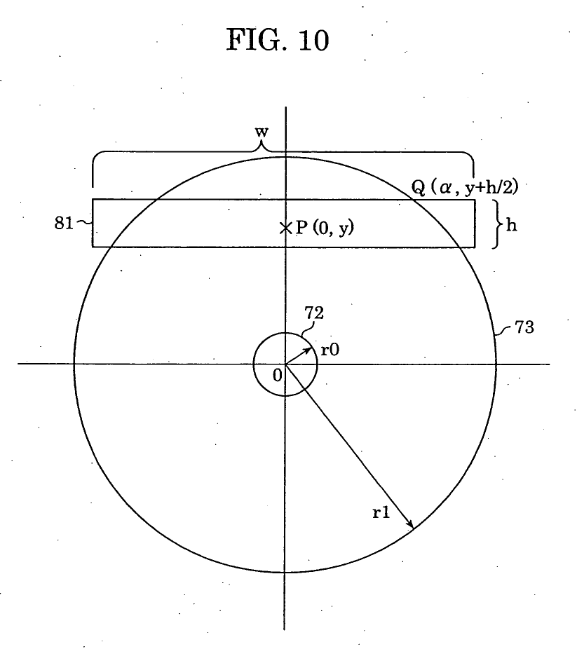

FIG. 10 shows relationships among the inner diameter 72, the outer diameter 73, and the text rendering region 81 of the printable medium in the present embodiment. Point O indicates the center of the concentric circles of the inner and outer diameters 72 and 73, r0 indicates the radius of the inner diameter 72, and r1 indicates the radius of the outer diameter 73. Further, point P (0, y) indicates the center (i.e., the center of gravity) of the given text rendering region 81, w indicates the width of the text rendering region 81, and h indicates the height.

When the width of he text rendering region 81 is short enough not to intersect the outer diameter 73, there is no need to adjust the text rendering region 81 and thus the text can be rendered in the same manner as the second embodiment. When a longitudinal side of the text rendering region 81 intersects the outer diameter 73 as shown in FIG. 10, characters partly protrude from the printable region, thereby causing the text to be truncated. Thus, in this case, reducing the width w of the text rendering region 81 can prevent characters to be rendered from protruding.

Point Q indicates a point at which the upper side of the text rendering region 81 intersects the outer diameter 73 and α indicates the x-coordinate of point Q. Since point Q is a point located along the upper side of the text rendering region 81, the y-coordinate is defined as (y+h/2). Since point Q is also a point on the outer diameter 73, the distance from the origin O is expressed by r1.

Thus, the following relationship is given:
α²+(y+h/2)² =r1²
Therefore,
α=√(r1²−(y+h/2)²)
The text rendering region 81 can be fit within the outer diameter 73 by reducing the width of the text rendering region 81 to point Q, i.e., reducing the width w so as to satisfy the following:
w←2√(r1²−(y+h/2)²)

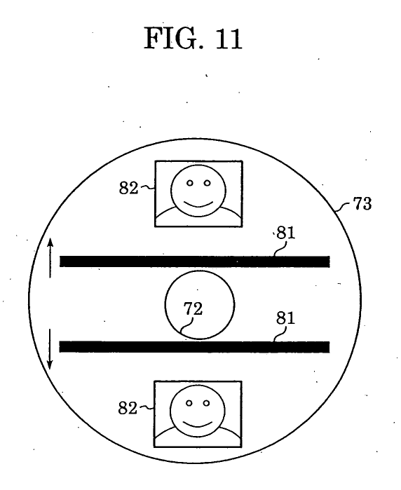

Although the text rendering region 81 is restricted by the inner diameter 72 and the outer diameter 73 in the third embodiment, the present invention is not limited thereto. For example, the present invention may also be applied to a case in which the text rendering region 81 is restricted by other printing elements, such as images 82 including pictures, as shown in FIG. 11. In the example shown in FIG. 11, each text rendering region 81, which moves toward the outer circumference (i.e., toward the outer diameter 73) as the inner diameter 72 increases, may move immediately before coming into contact with the corresponding image 82, rather than intersecting the outer diameter 73. This arrangement eliminates the need for overwriting the text to the image 82.

### Other Embodiments

Software program code that realizes the features of the illustrated embodiments may be supplied to a computer in the system or apparatus which is connected to various devices, so that in accordance with the program stored in the computer (or CPU or MPU) in the system or apparatus, the various devices are operated. Such an arrangement is also encompassed by the present invention.

In such a case, the software program code itself realizes the features of the illustrated embodiment, and thus the program code is covered by the present invention. Further, means for supplying the program code to the computer, a storage medium in which the program code is stored, and so on are also covered by the present invention. Examples of an available storage medium for storing such program code include a flexible disk, hard disk, optical disk, magneto-optical disk, CD-ROM, magnetic tape, nonvolatile memory card, and ROM.

Further, not only is the supplied program code executed by the computer to achieve the features of the illustrated embodiments, but also the program code may be executed by an operating system (OS) or the like that is running on the computer or in cooperation with other application software and so on to achieve the features of the illustrated embodiment. In such a case, the program code is also covered by the present invention.

Additionally, after the supplied program code is stored in a memory that is provided in a plug-in board inserted into the computer or an expansion unit connected to the computer, a CPU or the like that is provided in the plug-in board or the expansion unit may perform part or all of the actual processing in accordance with an instruction of the program code to achieve the features of the illustrated embodiments. Such an arrangement is also encompassed by the present invention.

As described above, when an image is displayed, the image data of a region of the image, the region being corresponding to a character rendering region, is saved and characters are rendered to the image data. Subsequently, the saved image data is rendered back to the image data to restore the original image. With this arrangement, characters can be displayed superimposed on an image, without flicker, with a less amount of memory used and less processing load compared to the conventionally available approach that employs double buffering.

In addition, at least one of the position and the size of a character rendering region, to which characters are to be rendered, is automatically adjusted, for example, depending on a printable region of a circular printing medium. Thereafter, control is performed such that characters-specified according to the character rendering region are printed on the circular printing medium. With this arrangement, the characters can be printed within the printable region without a need for re-setting the character rendering region.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

1.-19. (canceled)

20. An image processing apparatus comprising:
character specifying means for specifying characters that are to be rendered in a specified character rendering region and that are to be printed on a printing medium having a circular printable surface by printing means;
adjusting means for adjusting at least one of a position and a size of the character rendering region in accordance with a printable region defined by the inner diameter and the outer diameter of the circular printing medium; and
print controlling means for controlling the printing means such that the characters specified by the character specifying means are printed on the circular printing medium, in accordance with the character rendering region adjusted by the adjusting means.

21. The image processing apparatus according to claim 20, further comprising setting means for setting the inner diameter and the outer diameter of the circular printing medium, wherein the adjusting means adjusts at least one of the position and the size of the character rendering region in accordance with the set inner diameter and outer diameter.

22. The image processing apparatus according to claim 20, further comprising region specifying means for specifying the character rendering region.

23. The image processing apparatus according to claim 20, further comprising character-size changing means for changing a font size for the characters in accordance with the characters to be rendered and the size of the character rendering region.

24. The image processing apparatus according to claim 23, wherein the character-size changing means comprises rendering-width outputting means for determining or measuring a rendering width when the characters to be rendered are rendered with a pre-set font size; comparing means for comparing the rendering width obtained by the rendering-width outputting means with the size of the character rendering region; and changing means for changing the font size in accordance with a result of the comparison by the comparing means.

25. An image processing method comprising:
a character specifying step of specifying characters that are to be rendered in a specified character rendering region and that are to be printed on a printing medium having a circular printable surface by printing means;
an adjusting step of adjusting at least one of a position and a size of the character rendering region in accordance with a printable region defined by the inner diameter and the outer diameter of the circular printing medium; and
a print controlling step of controlling the printing means such that the characters specified in the character specifying step are printed on the circular printing medium, in accordance with the adjusted character rendering region.

26. A program for causing a computer, to function as:
character specifying means for specifying characters that are to be rendered in a specified character rendering region and that are to be printed on a printing medium having a circular printable surface by printing means;
adjusting means for adjusting at least one of a position and a size of the character rendering region in accordance with a printable region defined by the inner diameter and the outer diameter of the circular printing medium; and
print controlling means for controlling the printing means such that the characters specified by the character specifying means are printed on the circular printing medium, in accordance with the character rendering region adjusted by the adjusting means.

27. A computer-readable storage medium that stores a program comprising:
a character specifying step of specifying characters that are to be rendered in a specified character rendering region and that are to be printed on a printing medium having a circular printable surface by printing means;
an adjusting step of adjusting at least one of a position and a size of the character rendering region in accordance with a printable region defined by the inner diameter and the outer diameter of the circular printing medium; and
a print controlling step of controlling the printing means such that the characters specified in the character specifying step are printed on the circular printing medium, in accordance with the character rendering region adjusted in the adjusting step.
